(19) United States
(12) Patent Application Publication
(10) Pub. No.: US 2022/0222941 A1
(43) Pub. Date: Jul. 14, 2022

(54) METHOD FOR RECOGNIZING ACTION, ELECTRONIC DEVICE AND STORAGE MEDIUM

(71) Applicant: BEIJING BAIDU NETCOM SCIENCE TECHNOLOGY CO., LTD., Beijing (CN)

(72) Inventors: Desen ZHOU, Beijing (CN); Jian WANG, Beijing (CN); Hao SUN, Beijing (CN)

(21) Appl. No.: 17/707,657

(22) Filed: Mar. 29, 2022

(30) Foreign Application Priority Data
Jul. 30, 2021 (CN) 202110871172.6

(51) Int. Cl. G06V 20/40; G06V 20/52; G06V 10/82; G06T 3/40

(52) U.S. Cl. CPC G06V 20/44; G06T 3/4046; G06V 10/82; G06V 20/52

(57) ABSTRACT

A method for recognizing an action includes: obtaining a sequence for key points; extracting first space-time features corresponding to the sequence; obtaining a second space-time feature corresponding to a time granularity by performing feature extraction on the first space-time features based on the time granularity; and obtaining a target recognized action of the sequence based on second space-time features corresponding to time granularities.

### CROSS-REFERENCE TO RELATED APPLICATION

This application claims priority to Chinese Patent Application No. 202110871172.6, filed on Jul. 30, 2021, the entire content of which is incorporated herein by reference.

### TECHNICAL FIELD

The disclosure relates to the field of computer technology, and in particular to a method for recognizing an action, an electronic device, a storage medium and a computer program product.

### BACKGROUND

Currently, with the development of artificial intelligence (AI) technology, action recognition has been widely used in intelligent monitoring, video analysis and other fields. For example, in an intelligent monitoring scene, when an abnormal behavior is identified through action recognition on human behaviors in a video collected by a camera, an alarm can be issued, so that intelligent monitoring and alarm on human behaviors can be realized. In a video analysis scene, automatic classification of videos can be achieved by recognizing human actions in videos and classifying the videos according to action recognition results. However, the performance and accuracy of action recognition methods in the related art are low.

### SUMMARY

According to a first aspect, a method for recognizing an action is provided. The method includes: obtaining a sequence for key points; extracting first space-time features corresponding to the sequence; obtaining a second space-time feature corresponding to a time granularity by performing feature extraction on the first space-time features based on the time granularity; and obtaining a target recognized action of the sequence based on second space-time features corresponding to time granularities.

According to a second aspect, an electronic device is provided. The electronic device includes at least one processor and a memory communicatively coupled to the at least one processor. The memory is configured to store instructions executable by the at least one processor, and when the instructions are executed by the at least one processor, the at least one processor is caused to perform the above method for recognizing an action.

According to a third aspect, a non-transitory computer-readable storage medium having computer instructions stored thereon is provided. The computer instructions are configured to cause a computer to perform the above method for recognizing an action.

It should be understood that the content described in this section is not intended to identify key or important features of embodiments of the disclosure, nor is it intended to limit the scope of the disclosure. Additional features of the disclosure will be easily understood based on the following description.

### BRIEF DESCRIPTION OF THE DRAWINGS

The drawings are used to better understand solutions and do not constitute a limitation to the disclosure, in which:

FIG. 1 is a flowchart of a method for recognizing an action according to a first embodiment of the disclosure.

FIG. 2 is a flowchart of a method for recognizing an action according to a second embodiment of the disclosure.

FIG. 3 is a flowchart of a method for recognizing an action according to a third embodiment of the disclosure.

FIG. 4 is a flowchart of a method for recognizing an action according to a fourth embodiment of the disclosure.

FIG. 5 is a block diagram of a model for recognizing an action according to a first embodiment of the disclosure.

FIG. 6 is a block diagram of an apparatus for recognizing an action according to a first embodiment of the disclosure.

FIG. 7 is a block diagram of an electronic device for implementing a method for recognizing an action of embodiments of the disclosure.

### DETAILED DESCRIPTION

The following describes embodiments of the disclosure with reference to the drawings, which includes various details of embodiments of the disclosure to facilitate understanding and shall be considered merely exemplary. Therefore, those of ordinary skill in the art should recognize that various changes and modifications can be made to embodiments described herein without departing from the scope of the disclosure. For clarity and conciseness, descriptions of well-known functions and structures are omitted in the following description.

AI is a technical science that studies and develops theories, methods, technologies and application systems for simulating, extending and expanding human intelligence. Currently, AI technology has been widely used due to advantages of high degree of automation, high accuracy and low cost.

Computer vision refers to the use of cameras and computers instead of human eyes to identify, track and measure targets and further perform graphics processing, to make computers process images to be more suitable for human eyes to observe or transmit to instruments for detection. Computer vision is a comprehensive discipline that includes computer science and engineering, signal processing, physics, applied mathematics and statistics, neurophysiology and cognitive science.

Image processing refers to the technology of analyzing images with a computer to achieve desired results. Image processing generally refers to digital image processing. Digital image refers to a large two-dimensional array obtained by shooting with industrial cameras, cameras, scanners and other devices. The elements of the array are called pixels, and their values are called gray values. Image processing technology generally includes three parts, i.e., image compression, enhancement and restoration, matching, description and recognition.

Action recognition refers to understanding human actions and behaviors in videos, which is a challenging problem in the fields of computer vision and intelligent video analysis, and is also the key to understanding video content. Action recognition has been widely used in the detection and alarm of abnormal human behaviors through intelligent monitoring cameras, and in the classification and retrieval of human behaviors in videos.

Intelligent video system (IVS) refers to the use of computer image visual analysis technology to analyze and track targets appearing in a camera scene by separating the background and the targets in the camera scene. Video analysis technology is based on AI, image analysis, computer vision and other technologies, and is developing in the direction of digitization, networking and intelligence.

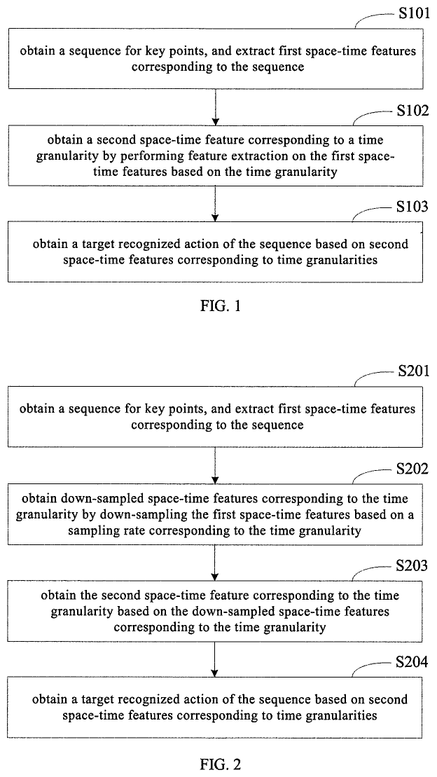

FIG. 1 is a flowchart of a method for recognizing an action according to a first embodiment of the disclosure.

As illustrated in FIG. 1, the method for recognizing an action according to a first embodiment of the disclosure includes the following.

In S101, a sequence for key points is obtained, and first space-time features corresponding to the sequence are extracted.

It should be noted that an execution body of the method for recognizing an action in some embodiments of the disclosure may be a hardware device with data information processing capability and/or software for driving the hardware device. Optionally, the executive body may include workstations, servers, computers, user terminals and other intelligent devices. The user terminals include but are not limited to mobile phones, computers, intelligent voice interaction devices, smart home appliances and vehicle-mounted terminals.

It should be noted that in some embodiments of the disclosure, types for key points are not limited. For example, when a target is a human body, the key points include but are not limited to limb key points and joint key points.

In some embodiments of the disclosure, a sequence for key points is obtained. It is understood that the sequence for key points may include position information and time information of a plurality of key points, that is, information in a time dimension and a space dimension. The position information includes but is not limited to two-dimensional coordinates and three-dimensional coordinates. For example, the sequence for key points may include three-dimensional coordinates of 18 key points in 30 image frames.

In some embodiments, the position information of the key points may be collected according to a preset sampling frequency within a sampling time period, to generate the sequence for key points. The sampling time period and sampling frequency can be set according to the actual situation, which are not limited herein. For example, the sampling time period can be set to 10:10:00 am to 10:10:05 am, and the sampling frequency can be set to 30 frames per second, that is, 30 image frames are collected per second, and the position information of the key points in each image frame is collected.

In some embodiments, the first space-time features corresponding to the sequence are extracted. It should be noted that the space-time features refer to features obtained by combining the time dimension and the space dimension of the sequence for key points.

In some embodiments, the first space-time features may include multiple types of space-time features, that is, the first space-time features are multi-scale. For example, the first space-time features include, but are not limited to, distances of the same key point in different frames, distances between different key points in the same frame, and distances between different key points in different frames, which are not limited herein.

In some embodiments, the first space-time features can be extracted from the sequence for key points based on a preset feature extraction algorithm. The feature extraction algorithm may be set according to the actual situation, which is not limited herein. For example, the feature extraction algorithm may include graph convolution networks (GCN).

In some embodiments, multiple scales-graph convolution networks 3Dimension (MS-G3D) is adopted to extract the first space-time features corresponding to the sequence from the sequence for key points.

In S102, a second space-time feature corresponding to a time granularity is obtained by performing feature extraction on the first space-time features based on the time granularity.

It should be noted that, in some embodiments of the disclosure, the time granularity may represent a sparsity of space-time features in the time dimension.

In some embodiments of the disclosure, feature extraction can be performed on the first space-time features based on the time granularity, to obtain the second space-time feature corresponding to the time granularity, so as to obtain second space-time features with different sparsity.

In some embodiments, the second space-time feature corresponding to the time granularity may be extracted from the first space-time features based on the preset feature extraction algorithm. The feature extraction algorithm may be set according to the actual situation, which is not limited herein. For example, the feature extraction algorithm may include GCNs. It is understood that different time granularities may correspond to different feature extraction algorithms.

In S103, a target recognized action of the sequence is obtained based on second space-time features corresponding to time granularities.

In some embodiments, the target recognized action of the sequence is obtained based on the second space-time features corresponding to the time granularities, which may include obtaining candidate recognized actions of the sequence based on the second space-time feature corresponding to any time granularity, and selecting the target recognized action from the candidate recognized actions.

Optionally, the target recognized action is selected from the candidate recognized actions, which may include determining a candidate recognized action with a largest number as the target recognized action. It can be understood that if the candidate recognized action with the largest number is more likely to be the target recognized action, the candidate recognized action with the largest number may be determined as the target recognized action.

For example, 3 time granularities corresponding to the second space-time features f1, f2, f3 respectively can be set, and the candidate recognized actions of the sequence obtained according to the second space-time features f1, f2, f3 are writing, typing, and typing. It is known that the number of typing is the largest, and typing can be used as the target recognized action of the sequence.

In conclusion, according to the method for recognizing an action of some embodiments of the disclosure, the second space-time features corresponding to the time granularities can be extracted from the sequence for key points. Based on the second space-time features corresponding to the time granularities, the target recognized action of the sequence is obtained. Therefore, the influence of the second space-time features corresponding to the time granularities on the action recognition can be comprehensively considered, which helps to improve the performance and accuracy of the action recognition.

FIG. 2 is a flowchart of a method for recognizing an action according to a second embodiment of the disclosure.

As illustrated in FIG. 2, the method for recognizing an action according to the second embodiment of the disclosure includes the following.

In S201, a sequence for key points is obtained, and first space-time features corresponding to the sequence are extracted.

For the relevant content of S201, reference may be made to the foregoing embodiments, and details are not repeated herein.

In S202, down-sampled space-time features corresponding to the time granularity are obtained by down-sampling the first space-time features based on a sampling rate corresponding to the time granularity.

In some embodiments of the disclosure, different time granularities may correspond to different sampling rates. The sparsity corresponding to the time granularity is positively correlated with the sampling rate, that is, a dense time granularity corresponds to a larger sampling rate, and a sparse time granularity corresponds to a smaller sampling rate.

In some embodiments, the sampling rate includes but is not limited to 1, 1/2, and 1/4, which is not limited herein.

In some embodiments, the down-sampled space-time features corresponding to the time granularity are obtained by down-sampling the first space-time features based on the sampling rate corresponding to the time granularity. The above process includes: obtaining a sampling period based on any sampling rate, and obtaining the down-sampled space-time features corresponding to the time granularity by down-sampling the first space-time features based on the corresponding sampling period.

It can be understood that different sampling rates may correspond to different sampling periods. For example, the sampling periods corresponding to the sampling rates of 1, 1/2, and 1/4 are one frame, two frames, and four frames, respectively. When the sampling rate is 1, the down-sampled space-time features can be obtained from the first space-time features corresponding to every one frame. When the sampling rate is 1/2, the down-sampled space-time features can be obtained from the first space-time features corresponding to every two frames. When the rate is 1/4, the down-sampled space-time features can be obtained from the first space-time features corresponding to every four frames.

In S203, the second space-time feature corresponding to the time granularity is obtained based on the down-sampled space-time features corresponding to the time granularity.

It can be understood that the down-sampled space-time features corresponding to the time granularities can correspond to different sparsity, and the second space-time feature corresponding to the time granularity can be obtained based on the down-sampled space-time features corresponding to the time granularity.

In some embodiments, the down-sampled space-time features corresponding to the time granularity can be directly determined as the second space-time feature corresponding to the time granularity.

In some embodiments, the second space-time feature corresponding to the time granularity is obtained based on the down-sampled space-time features corresponding to the time granularity. The process includes: obtaining a feature extraction structure of any one of the down-sampled space-time features based on a sampling rate corresponding to the corresponding down-sampled space-time feature; and obtaining the second space-time feature by performing feature extraction on the corresponding down-sampled space-time feature based on the feature extraction structure. Thus, the method can obtain the feature extraction structure of the down-sampled space-time features corresponding to the time granularity, that is, the down-sampled space-time features corresponding to different time granularities adopt different feature extraction structures, which can be used for performing feature extraction on the down-sampled space-time features with different sparsity based on different strategies, which has high flexibility and helps to improve the representation effect of the second space-time features.

It is understood that different sampling rates can correspond to different feature extraction structures.

In some embodiments, the feature extraction structure includes graph convolution networks 3Dimension (G3D) layers, and a number of the G3D layers is positively related to the sampling rate. It is known that the larger the sampling rate is, the denser the down-sampled space-time features is, that is, the number of G3D layers corresponding to the dense down-sampled space-time features is larger, the dense second space-time feature is extracted from the dense down-sampled space-time features, and the number of G3D layers corresponding to the sparse down-sampled space-time features is small, the sparse second space-time feature is extracted from the sparse down-sampled space-time features.

For example, there are 3 time granularities, and the down-sampled space-time features are sorted according to the sparsity in a descending order. The sorting result is the down-sampled space-time features f1, f2, and f3, then the sampling rates corresponding to the down-sampled space-time features f1, f2, and f3 decrease step by step. The number of G3D layers corresponding to the down-sampled space-time features f1, f2, and f3 are 2, 1, and 0, respectively.

In S204, a target recognized action of the sequence is obtained based on second space-time features corresponding to time granularities.

For the relevant content of S204, reference may be made to the above-mentioned embodiments, which will not be repeated here.

In conclusion, according to the method for recognizing an action according to some embodiments of the disclosure, the down-sampled space-time features corresponding to the time granularity are obtained by down-sampling the first space-time features based on the sampling rate corresponding to the time granularity. The second space-time feature corresponding to the time granularity is obtained based on the down-sampled space-time features corresponding to the time granularity. Thus, the second space-time feature corresponding to the time granularity is obtained by down-sampling the first space-time features.

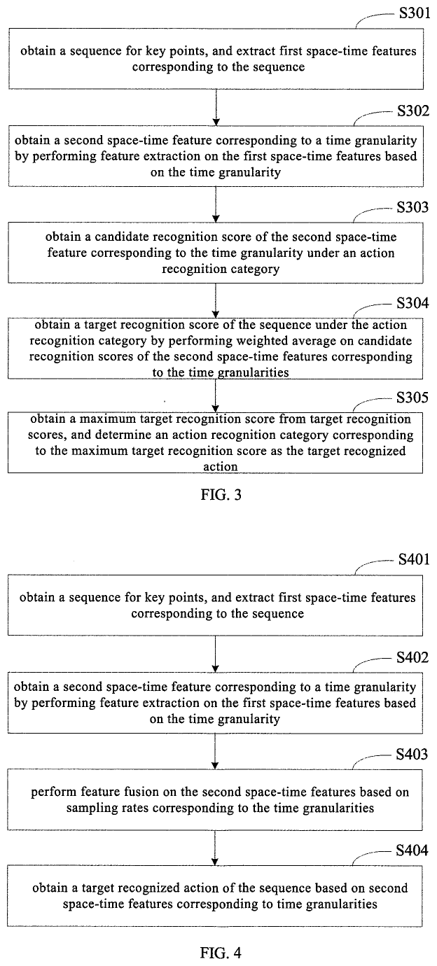

FIG. 3 is a flowchart of a method for recognizing an action according to a third embodiment of the disclosure.

As illustrated in FIG. 3, the method for recognizing an action according to the third embodiment of the disclosure includes the following.

In S301, a sequence for key points is obtained, and first space-time features corresponding to the sequence are extracted.

In S302, a second space-time feature corresponding to a time granularity is obtained by performing feature extraction on the first space-time features based on the time granularity.

For the relevant content of S301-S302, reference may be made to the foregoing embodiments, and details are not repeated here.

In S303, a candidate recognition score of the second space-time feature corresponding to the time granularity under an action recognition category is obtained.

In some embodiments of the disclosure, the action recognition category can be set according to the actual situation, which is not limited herein. For example, the action recognition category includes but is not limited to writing, typing, and touching mouse.

In some embodiments, the candidate recognition score of the second space-time feature corresponding to the time granularity under the action recognition category is obtained based on a preset classification algorithm. The classification algorithm can be set according to the actual situation, for example, deep learning algorithm, which is not limited herein.

For example, 3 time granularities corresponding to second space-time features f₁, f₂, f₃ respectively can be set, action recognition categories a, b, c, d are set, and candidate recognition scores of the second space-time features f₁, f₂, and f₃ under the action recognition categories a, b, c, and d can be obtained. For example, the candidate recognition scores of the second space-time feature f₁ under the action recognition categories a, b, c, and d, are P₁ to P₄ respectively. The candidate recognition scores of the second space-time feature f₂ under the action recognition categories a, b, c, and d, are P₅ to P₈ respectively. The candidate recognition scores of the second space-time feature f₃ under the action recognition categories a, b, c, and d, are P₉ to P₁₂ respectively.

In S304, a target recognition score of the sequence under the action recognition category is obtained by performing weighted average on candidate recognition scores of the second space-time features corresponding to the time granularities.

In some embodiments of the disclosure, a product of the candidate recognition score and a weight of the second space-time feature corresponding to the time granularity under the action recognition category can be obtained, and an averaged value of products can be determined as the target recognition score of the sequence under the action recognition category.

It can be understood that different time granularities may correspond to different weights.

For example, 3 time granularities corresponding to second space-time features f₁, f₂, f₃ respectively can be set, corresponding weights are 0.3, 0.5, and 0.2, respectively, there are action recognition categories a, b, c, and d, candidate recognition scores of the second space-time features f₁, f₂, and f₃ under the action recognition categories a, b, c, and d can be obtained. For example, the candidate recognition scores of the second space-time feature f₁ under action recognition categories a, b, c, and d, are P₁ to P₄ respectively. The candidate recognition scores under the action recognition categories a, b, c, and d of the second space-time feature f₂ are P₅ to P₈ respectively. The candidate recognition scores under the action recognition categories a, b, c, and d of the second space-time feature f₃ are P₉ to P₁₂ respectively.

For the action recognition category a, the candidate recognition scores P₁, P₅ and P₉ of the second space-time features f₁, f₂, and f₃ corresponding to the time granularities under the action recognition category a can be obtained, and Pₐ=(P₁*0.3+P₅*0.5+P₉*0.2)/3 is the target recognition score of the sequence under the action recognition category a.

For the action recognition category b, the candidate recognition scores P₂, P₆ and P₁₀ of the second space-time features f₁, f₂, and f₃ corresponding to the time granularities under the action recognition category b can be obtained, and P_{b}=(P₂*0.3+P₆*0.5+P₁₀*0.2)/3 is the target recognition score of the sequence under the action recognition category b.

For the action recognition category c, the candidate recognition scores P₃, P₇ and P₁₁ of the second space-time features f₁, f₂, and f₃ corresponding to the time granularities under the action recognition category c can be obtained, and P_{c}=(P₃*0.3+P₇*0.5+P₁₁*0.2)/3 is the target recognition score of the sequence under the action recognition category c.

For the action recognition category d, the candidate recognition scores P₄, P₈ and P₁₂ of the second space-time features f₁, f₂, and f₃ corresponding to the time granularities under the action recognition category d can be obtained, and P_{d}=(P₄*0.3+P₈*0.5+P₁₂*0.2)/3 is the target recognition score of the sequence under the action recognition category d.

In S305, a maximum target recognition score is obtained from target recognition scores, and an action recognition category corresponding to the maximum target recognition score is determined as the target recognized action.

In some embodiments of the disclosure, the target recognition score of the sequence under the action recognition category can be obtained. It is understood that the higher the target recognition score, the closer the action recognition category is to the actual action category. The maximum target recognition score is obtained from the target recognition scores, and the action recognition category corresponding to the maximum target recognition score is determined as the target recognized action.

For example, the maximum target recognition score in the target recognition scores Pₐ, P_{b}, P_{c} and P_{d} of the sequence under the action recognition categories a, b, c, and d is P_{c}, then the action recognition category c corresponding to the maximum target recognition score P_{c} is determined as the target recognized action.

In conclusion, according to the method for recognizing an action of some embodiments of the disclosure, the target recognition score of the sequence under the action recognition category is obtained by performing weighted average on candidate recognition scores of the second space-time features corresponding to the time granularities, and the action recognition category corresponding to the maximum target recognition score is determined as the target recognized action. Therefore, the influence of the second space-time features corresponding to the time granularities on action recognition can be comprehensively considered, which helps to improve the performance and accuracy of action recognition.

FIG. 4 is a flowchart of a method for recognizing an action according to a fourth embodiment of the disclosure.

As illustrated in FIG. 4, the method for recognizing an action according to the fourth embodiment of the disclosure includes the following.

In S401, a sequence for key points is obtained, and first space-time features corresponding to the sequence are extracted.

In S402, a second space-time feature corresponding to a time granularity is obtained by performing feature extraction on the first space-time features based on the time granularity.

For the relevant content of S401-S402, reference may be made to the foregoing embodiments, which will not be repeated here.

In S403, feature fusion is performed on the second space-time features based on sampling rates corresponding to the time granularities.

In some embodiments of the disclosure, feature fusion may be performed on the second space-time features. It is understood that the second space-time features corresponding to the time granularities have different sparsity, and this manner can perform feature fusion on the second space-time features based on different sparsity, to enhance the representation effect of the second space-time features.

In some embodiments of the disclosure, feature fusion may be performed on the second space-time features according to the sampling rates corresponding to the time granularities. For example, the feature fusion strategy of the second space-time features corresponding to the time granularities may be determined according to the sampling rates corresponding to the time granularities. The feature fusion strategy may be set according to the actual situation, which is not limited here.

In some embodiments, performing feature fusion on the second space-time features based on the sampling rates corresponding to the time granularities includes: sorting the second space-time features based on sparsity in a descending order, in which the sparsity is positively related to the sampling rate; generating a fused space-time feature by performing feature fusion on, starting from a second space-time feature ranked first, a second space-time feature currently traversed with a next adjacent second space-time feature; and updating the next second space-time feature with the fused space-time feature until the last second space-time feature is updated. Thus, the manner can perform feature fusion on the dense second space-time feature and the sparse second space-time feature to generate the fused space-time feature, and update the sparse second space-time feature with the fused space-time feature. The fused space-time feature can make up for the disadvantage that the sparse second space-time feature has fewer features in the time dimension, which helps to enhance the representation effect of the sparse space-time feature.

For example, 3 time granularities corresponding to second space-time features f₁, f₂ and f₃ respectively can be set, the second space-time features f₁, f₂ and f₃ are sorted according to the sparsity in a descending order, and the sorted result is f₃, f₂ and f₁. Then f₃ and f₂ are fused to generate a fused space-time feature f₂′, and the second space-time feature f₂ can be updated with the fused space-time feature f₂′, and f₂′ and f₁ are fused to generate a fused space-time feature f₁′, and the second space-time features f₁ is updated with the fused space-time feature f₁′.

It should be noted that, in some embodiments of the disclosure, the manner of feature fusion is not limited. For example, feature fusion can be performed on the second space-time features through the preset feature fusion algorithm, and the feature fusion algorithm can be set according to the actual situation, which is not limited herein.

In S404, a target recognized action of the sequence is obtained based on second space-time features corresponding to time granularities.

For the relevant content of S404, reference may be made to the above embodiments, and details are not repeated here.

In conclusion, according to the method for recognizing an action of some embodiments of the disclosure, before obtaining the target recognized action of the sequence based on the second space-time features corresponding to the time granularities, feature fusion is performed on the second space-time features based on the sampling rates corresponding to the time granularities. Therefore, the influence of the sampling rates corresponding to the time granularities on the feature fusion of the second space-time features can be considered, and the feature fusion is more flexible, which helps to enhance the representation effect of the second space-time features, and improve the performance and accuracy of action recognition.

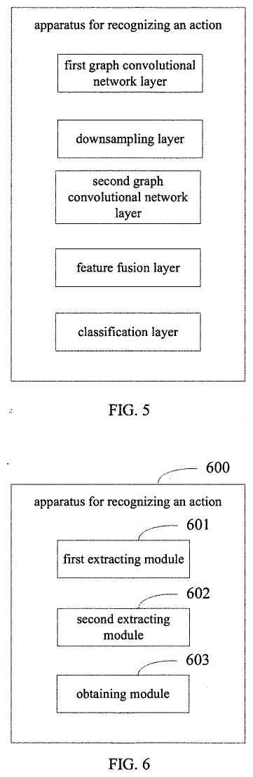

Corresponding to the method for recognizing an action according to the above embodiments of FIGS. 1 to 4, as illustrated in FIG. 5, the disclosure also provides a model for recognizing an action, the input of the model is the sequence for key points, and the output is the target recognized action of the sequence.

As illustrated in FIG. 5, the model for recognizing an action includes a first graph convolutional network layer, a down-sampling layer, a second graph convolutional network layer, a feature fusion layer and a classification layer.

The first graph convolutional network layer is configured to extract the first space-time features corresponding to the sequence.

The down-sampling layer is configured to obtain the down-sampled space-time features corresponding to the time granularity by down-sampling the first space-time features based on the sampling rate corresponding to the time granularity.

The second graph convolutional network layer includes a plurality of feature extraction structures. The feature extraction structures correspond to the sampling rates corresponding to the down-sampled space-time features. The feature extraction structure is configured to obtain the second space-time feature corresponding to the time granularity by performing feature extraction on any down-sampled space-time feature.

The feature fusion layer is configured to perform feature fusion on the second space-time features based on sampling rates corresponding to the time granularities.

The classification layer is configured to obtain the target recognized action of the sequence based on the second space-time features corresponding to the time granularities.

In conclusion, with the model for recognizing an action according to some embodiments of the disclosure, the second space-time features corresponding to the time granularities are extracted from the sequence for key points. The target recognized action of the sequence is obtained based on the second space-time features corresponding to the time granularities. Therefore, the influence of the second space-time features corresponding to the time granularities on action recognition can be comprehensively considered, which helps to improve the performance and accuracy of action recognition.

FIG. 6 is a block diagram of an apparatus for recognizing an action according to a first embodiment of the disclosure.

As illustrated in FIG. 6, the apparatus for recognizing an action 600 in some embodiments of the disclosure includes a first extracting module 601, a second extracting module 602 and an obtaining module 603.

The first extracting module 601 is configured to obtain a sequence for key points and extract first space-time features corresponding to the sequence.

The second extracting module 602 is configured to obtain a second space-time feature corresponding to a time granularity by performing feature extraction on the first space-time features based on the time granularity.

The obtaining module 603 is configured to obtain a target recognized action of the sequence based on second space-time features corresponding to time granularities.

In some embodiments of the disclosure, the second extracting module 602 includes a down-sampling unit and an obtaining unit. The down-sampling unit is configured to obtain down-sampled space-time features corresponding to the time granularity by down-sampling the first space-time features based on a sampling rate corresponding to the time granularity. The obtaining unit is configured to obtain the second space-time feature corresponding to the time granularity based on the down-sampled space-time features corresponding to the time granularity.

In some embodiments of the disclosure, the obtaining unit is further configured to: obtain a feature extraction structure of any one of the down-sampled space-time features based on a sampling rate corresponding to the corresponding down-sampled space-time feature; and obtain the second space-time feature by performing feature extraction on the corresponding down-sampled space-time feature based on the feature extraction structure.

In some embodiments of the disclosure, the feature extraction structure includes graph convolution networks 3Dimension (G3D) layers, and a number of the G3D layers is positively related to the sampling rate.

In some embodiments of the disclosure, the obtaining module 603 is further configured to: obtain a candidate recognition score of the second space-time feature corresponding to the time granularity under an action recognition category; obtain a target recognition score of the sequence under the action recognition category by performing weighted average on candidate recognition scores of the second space-time features corresponding to the time granularities; obtain a maximum target recognition score from target recognition scores; and determine an action recognition category corresponding to the maximum target recognition score as the target recognized action.

In some embodiments of the disclosure, the apparatus 600 further includes a fusing module. The fusing module is configured to: perform feature fusion on the second space-time features based on sampling rates corresponding to the time granularities.

In some embodiments of the disclosure, the fusing module is further configured to: sort the second space-time features based on sparsity in a descending order, in which the sparsity is positively related to the sampling rate; generate a fused space-time feature by performing feature fusion on, starting from a second space-time feature ranked first, a second space-time feature currently traversed with a next adjacent second space-time feature; and update the next second space-time feature with the fused space-time feature until the last second space-time feature is updated.

In conclusion, the apparatus of some embodiments of the disclosure extracts the second space-time features corresponding to the time granularities from the sequence for key points, and obtains the target recognized action of the sequence based on the second space-time features corresponding to the time granularities. Therefore, the influence of the second space-time features corresponding to the time granularities on the action recognition can be comprehensively considered, which helps to improve the performance and accuracy of the action recognition.

In the technical solutions of the disclosure, acquisition, storage and application of the user's personal information involved all comply with the provisions of relevant laws and regulations, and do not violate public order and good customs.

According to some embodiments of the disclosure, the disclosure also provides an electronic device, a readable storage medium and a computer program product.

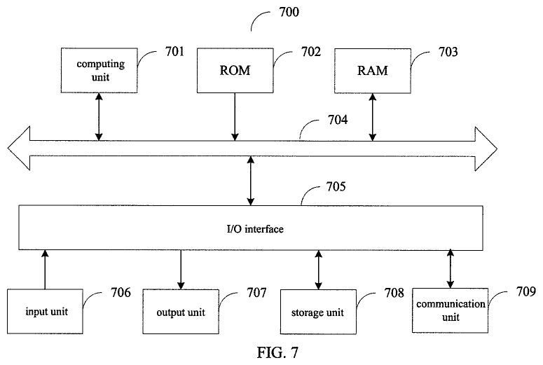

FIG. 7 is a block diagram of an electronic device 700 for implementing some embodiments of the disclosure. Electronic devices are intended to represent various forms of digital computers, such as laptop computers, desktop computers, workbenches, personal digital assistants, servers, blade servers, mainframe computers, and other suitable computers. Electronic devices may also represent various forms of mobile devices, such as personal digital processing, cellular phones, smart phones, wearable devices, and other similar computing devices. The components shown here, their connections and relations, and their functions are merely examples, and are not intended to limit the implementation of the disclosure described and/or required herein.

As illustrated in FIG. 7, the device 700 includes a computing unit 701 performing various appropriate actions and processes based on computer programs stored in a read-only memory (ROM) 702 or computer programs loaded from the storage unit 708 to a random access memory (RAM) 703. In the RAM 703, various programs and data required for the operation of the device 700 are stored. The computing unit 701, the ROM 702, and the RAM 703 are connected to each other through a bus 704. An input/output (I/O) interface 705 is also connected to the bus 704.

Components in the device 700 are connected to the I/O interface 705, including: an inputting unit 706, such as a keyboard, a mouse; an outputting unit 707, such as various types of displays, speakers; a storage unit 708, such as a disk, an optical disk, and a communication unit 709, such as network cards, modems, and wireless communication transceivers. The communication unit 709 allows the device 700 to exchange information/data with other devices through a computer network such as the Internet and/or various telecommunication networks.

The computing unit 701 may be various general-purpose and/or dedicated processing components with processing and computing capabilities. Some examples of computing unit 701 include, but are not limited to, a central processing unit (CPU), a graphics processing unit (GPU), various dedicated AI computing chips, various computing units that run machine learning model algorithms, and a digital signal processor (DSP), and any appropriate processor, controller and microcontroller. The computing unit 701 executes the various methods and processes described above, such as the method for recognizing an action. For example, in some embodiments, the method may be implemented as a computer software program, which is tangibly contained in a machine-readable medium, such as the storage unit 708. In some embodiments, part or all of the computer program may be loaded and/or installed on the device 700 via the ROM 702 and/or the communication unit 709. When the computer program is loaded on the RAM 703 and executed by the computing unit 701, one or more steps of the method described above may be executed. Alternatively, in other embodiments, the computing unit 701 may be configured to perform the method in any other suitable manner (for example, by means of firmware).

Various implementations of the systems and techniques described above may be implemented by a digital electronic circuit system, an integrated circuit system, Field Programmable Gate Arrays (FPGAs), Application Specific Integrated Circuits (ASICs), Application Specific Standard Products (ASSPs), System on Chip (SOCs), Load programmable logic devices (CPLDs), computer hardware, firmware, software, and/or a combination thereof. These various embodiments may be implemented in one or more computer programs, the one or more computer programs may be executed and/or interpreted on a programmable system including at least one programmable processor, which may be a dedicated or general programmable processor for receiving data and instructions from the storage system, at least one input device and at least one output device, and transmitting the data and instructions to the storage system, the at least one input device and the at least one output device.

The program code configured to implement the method of the disclosure may be written in any combination of one or more programming languages. These program codes may be provided to the processors or controllers of general-purpose computers, dedicated computers, or other programmable data processing devices, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage media include electrical connections based on one or more wires, portable computer disks, hard disks, random access memories (RAM), read-only memories (ROM), electrically programmable read-only-memory (EPROM), flash memory, fiber optics, compact disc read-only memories (CD-ROM), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: local area network (LAN), wide area network (WAN), the Internet and Block-chain network.

The computer system may include a client and a server. The client and server are generally remote from each other and interacting through a communication network. The client-server relation is generated by computer programs running on the respective computers and having a client-server relation with each other. The server can also be a cloud server, a server of a distributed system, or a server combined with a block-chain.

According to some embodiments of the disclosure, the disclosure further provides a computer program product, including computer programs. When the computer programs are executed by a processor, the method for recognizing an action described in the above embodiments of the disclosure is performed.

It should be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of the disclosure shall be included in the protection scope of the disclosure.

What is claimed is:

1. A method for recognizing an action, comprising:
obtaining a sequence for key points;
extracting first space-time features corresponding to the sequence;
obtaining a second space-time feature corresponding to a time granularity by performing feature extraction on the first space-time features based on the time granularity; and
obtaining a target recognized action of the sequence based on second space-time features corresponding to time granularities.

2. The method of claim 1, wherein obtaining the second space-time feature corresponding to the time granularity by performing feature extraction on the first space-time features based on the time granularity, comprises:
obtaining down-sampled space-time features corresponding to the time granularity by down-sampling the first space-time features based on a sampling rate corresponding to the time granularity; and
obtaining the second space-time feature corresponding to the time granularity based on the down-sampled space-time features corresponding to the time granularity.

3. The method of claim 2, wherein obtaining the second space-time feature corresponding to the time granularity based on the down-sampled space-time features corresponding to the time granularity, comprises:
obtaining a feature extraction structure of any one of the down-sampled space-time features based on a sampling rate corresponding to the corresponding down-sampled space-time feature; and
obtaining the second space-time feature by performing feature extraction on the corresponding down-sampled space-time feature based on the feature extraction structure.

4. The method of claim 3, wherein the feature extraction structure comprises graph convolution networks 3Dimension (G3D) layers, and a number of the G3D layers is positively related to the sampling rate.

5. The method of claim 1, wherein obtaining the target recognized action of the sequence based on the second space-time features corresponding to the time granularities, comprises:
obtaining a candidate recognition score of the second space-time feature corresponding to the time granularity under an action recognition category;
obtaining a target recognition score of the sequence under the action recognition category by performing weighted average on candidate recognition scores of the second space-time features corresponding to the time granularities;
obtaining a maximum target recognition score from target recognition scores; and
determining an action recognition category corresponding to the maximum target recognition score as the target recognized action.

6. The method of claim 2, further comprising:
performing feature fusion on the second space-time features based on sampling rates corresponding to the time granularities.

7. The method of claim 6, wherein performing feature fusion on the second space-time features based on the sampling rates corresponding to the time granularities, comprises:
sorting the second space-time features based on sparsity in a descending order, wherein the sparsity is positively related to the sampling rate;
generating a fused space-time feature by performing feature fusion on, starting from a second space-time feature ranked first, a second space-time feature currently traversed with a next adjacent second space-time feature; and
updating the next second space-time feature with the fused space-time feature until the last second space-time feature is updated.

8. An electronic device, comprising:
at least one processor; and
a memory communicatively coupled to the at least one processor; wherein,
the memory is configured to store instructions executable by the at least one processor, when the instructions are executed by the at least one processor, the at least one processor is enabled to perform:
obtaining a sequence for key points;
extracting first space-time features corresponding to the sequence;
obtaining a second space-time feature corresponding to a time granularity by performing feature extraction on the first space-time features based on the time granularity; and
obtaining a target recognized action of the sequence based on second space-time features corresponding to time granularities.

9. The electronic device of claim 8, wherein when the instructions are executed by the at least one processor, the at least one processor is enabled to perform:
obtaining down-sampled space-time features corresponding to the time granularity by down-sampling the first space-time features based on a sampling rate corresponding to the time granularity; and
obtaining the second space-time feature corresponding to the time granularity based on the down-sampled space-time features corresponding to the time granularity.

10. The electronic device of claim 9, wherein when the instructions are executed by the at least one processor, the at least one processor is enabled to perform:
obtaining a feature extraction structure of any one of the down-sampled space-time features based on a sampling rate corresponding to the corresponding down-sampled space-time feature; and
obtaining the second space-time feature by performing feature extraction on the corresponding down-sampled space-time feature based on the feature extraction structure.

11. The electronic device of claim 10, wherein the feature extraction structure comprises graph convolution networks 3Dimension (G3D) layers, and a number of the G3D layers is positively related to the sampling rate.

12. The electronic device of claim 8, wherein when the instructions are executed by the at least one processor, the at least one processor is enabled to perform:
obtaining a candidate recognition score of the second space-time feature corresponding to the time granularity under an action recognition category;
obtaining a target recognition score of the sequence under the action recognition category by performing weighted average on candidate recognition scores of the second space-time features corresponding to the time granularities;
obtaining a maximum target recognition score from target recognition scores; and
determining an action recognition category corresponding to the maximum target recognition score as the target recognized action.

13. The electronic device of claim 9, wherein when the instructions are executed by the at least one processor, the at least one processor is enabled to perform:
performing feature fusion on the second space-time features based on sampling rates corresponding to the time granularities.

14. The electronic device of claim 13, wherein when the instructions are executed by the at least one processor, the at least one processor is enabled to perform:
sorting the second space-time features based on sparsity in a descending order, wherein the sparsity is positively related to the sampling rate;
generating a fused space-time feature by performing feature fusion on, starting from a second space-time feature ranked first, a second space-time feature currently traversed with a next adjacent second space-time feature; and
updating the next second space-time feature with the fused space-time feature until the last second space-time feature is updated.

15. A non-transitory computer-readable storage medium storing computer instructions, wherein the computer instructions are configured to cause a computer to perform a method for recognizing an action, the method comprising:
obtaining a sequence for key points;
extracting first space-time features corresponding to the sequence;
obtaining a second space-time feature corresponding to a time granularity by performing feature extraction on the first space-time features based on the time granularity, and
obtaining a target recognized action of the sequence based on second space-time features corresponding to time granularities.

16. The non-transitory computer-readable storage medium of claim 15, wherein obtaining the second space-time feature corresponding to the time granularity by performing feature extraction on the first space-time features based on the time granularity, comprises:
obtaining down-sampled space-time features corresponding to the time granularity by down-sampling the first space-time features based on a sampling rate corresponding to the time granularity; and
obtaining the second space-time feature corresponding to the time granularity based on the down-sampled space-time features corresponding to the time granularity.

17. The non-transitory computer-readable storage medium of claim 16, wherein obtaining the second space-time feature corresponding to the time granularity based on the down-sampled space-time features corresponding to the time granularity, comprises:
obtaining a feature extraction structure of any one of the down-sampled space-time features based on a sampling rate corresponding to the corresponding down-sampled space-time feature; and
obtaining the second space-time feature by performing feature extraction on the corresponding down-sampled space-time feature based on the feature extraction structure.

18. The non-transitory computer-readable storage medium of claim 15, wherein obtaining the target recognized action of the sequence based on the second space-time features corresponding to the time granularities, comprises:
obtaining a candidate recognition score of the second space-time feature corresponding to the time granularity under an action recognition category;
obtaining a target recognition score of the sequence under the action recognition category by performing weighted average on candidate recognition scores of the second space-time features corresponding to the time granularities;
obtaining a maximum target recognition score from target recognition scores; and
determining an action recognition category corresponding to the maximum target recognition score as the target recognized action.

19. The non-transitory computer-readable storage medium of claim 16, wherein the method further comprises:
performing feature fusion on the second space-time features based on sampling rates corresponding to the time granularities.

20. The non-transitory computer-readable storage medium of claim 19, wherein performing feature fusion on the second space-time features based on the sampling rates corresponding to the time granularities, comprises:
sorting the second space-time features based on sparsity in a descending order, wherein the sparsity is positively related to the sampling rate;
generating a fused space-time feature by performing feature fusion on, starting from a second space-time feature ranked first, a second space-time feature currently traversed with a next adjacent second space-time feature; and
updating the next second space-time feature with the fused space-time feature until the last second space-time feature is updated.
